(19) United States
(12) Patent Application Publication
(10) Pub. No.: US 2005/0097952 A1
(43) Pub. Date: May 12, 2005

(54) Conductive sensor for fluid level sensing

(76) Inventors: James C. Steph, Kilgore, TX (US); Charles Robin Hood, Bullard, TX (US)

Correspondence Address: John M. Harrington;Kilpatrick Stockton LLP, 1001 West Fourth Street, Winston-Salem, NC, 27101, US

(21) Appl. No.: 10/987,138

(22) Filed: Nov. 12, 2004

Related U.S. Application Data
(60) Provisional application No. 60/519,125, filed on Nov. 12, 2003.

(51) Int. Cl. G01F 23/00

(52) U.S. Cl. 73/304 R; 340/620

(57) ABSTRACT

The invention relates to a device for sensing fluid level comprising a calibration sensor completely immersed in a fluid, and a measurement sensor at least partially immersed in the same fluid, wherein said calibration sensor is disposed in the fluid at a position lower than the lowest level of the measurement sensor. The calibration sensor and measurement sensors comprise elongated apertures in a printed circuit board with electrically conductive plating formed on each side of, and spanning the length of, the elongated apertures. Further, the invention relates to a method for determining a fluid level within a reservoir comprising: providing a calibration sensor completely immersed in the fluid and having a known length, providing a measurement sensor at least partially immersed in the fluid, sensing an electrical property of the fluid through the calibration sensor, sensing the same electrical property of the fluid through the measurement sensor, and determining the fluid level as it relates to the length of the measurement electrode exposed to the fluid.

### CROSS REFERENCE TO RELATED APPLICATIONS

The present application claims priority under 35 U.S.C. § 119(e) from U.S. Provisional Patent Application Ser. No. 60/519,125 filed Nov. 12, 2003, entitled “Conductive Sensor for Oil Level Sensing”, the disclosure of which is incorporated herein by reference.

### FIELD OF THE INVENTION

The present invention relates to an apparatus and method for sensing fluid level within a fluid reservoir. More particularly, the present invention relates to an apparatus and method for sensing oil level in a heavy-duty engine.

### BACKGROUND OF THE INVENTION

Typical oil level sensors use a capacitive sensor to determine fluid levels. Capacitive sensors operate by passing a current through the fluid from one electrode to another and measuring the dielectric properties of the fluid. The capacitance measured by the sensor will increase as the fluid level between the electrodes decreases. However, oils and other such lubricants degrade over time due to pressure, stresses and heat. Further, the presence of metallic or non-metallic particles in the lubricant due to wear of the surrounding components may have an effect on the electrical properties of the fluid.

As the fluid degrades or becomes contaminated, the electrical properties change. A traditional capacitive sensor is unable to distinguish between a change in capacitance due to degradation of the fluid and a change in capacitance resulting from a change in fluid level. Therefore, as the fluid ages, the ability of the sensor to accurately detect the fluid level decreases. Adding to this inaccuracy is the change in dielectric properties of the fluid resulting from changes in temperature and additives incorporated into the fluid.

Others have developed methods for monitoring the degradation of fluids over time. U.S. Pat. No. 5,933,016, issued Aug. 3, 1999, to Kauffman et al., and herein incorporated by reference in full, discloses a method and apparatus for the analysis of a fluid to determine the remaining useful life of the fluid and whether the fluid has become contaminated. The method can be performed either on-line or off-line; however, the on-line method is preferred. In the method, a sample of the fluid is contacted by a single electrode that is connected to the ground potential by means of the equipment in which the fluid is used. A current is applied to the sample through the electrode and the conductivity of the sample is measured. The conductivity measurement can then be compared to known values for the fluid to determine the remaining useful life of the fluid and whether the fluid has become contaminated.

However, knowing the degree of degradation of the fluid given by the Kauffman et al. method still does not overcome the problems of inaccurate fluid level measurements attributed to said degradation. It would, therefore, be desirable to have an apparatus and method for measuring fluid level electrically that operates independently of the degree of degradation or temperature of the fluid.

Therefore, there is a need for an apparatus and method for electronically measuring fluid level that operates independently of the dielectric properties of the fluid.

### SUMMARY OF THE INVENTION

A first aspect of the present invention provides a device for sensing fluid level comprising a calibration sensor completely immersed in a fluid, and a measurement sensor at least partially immersed in the same fluid, wherein said calibration sensor is disposed in the fluid at a position lower than the lowest level of the measurement sensor. In a preferred embodiment of the present invention, the calibration sensor and measurement sensor are disposed on a printed circuit board (PCB). The calibration sensor comprises an elongated aperture in the printed circuit board with electrically conductive plating formed on each side of, and spanning the length of, the elongated aperture. Similarly, the measurement sensor comprises an elongated aperture in the printed circuit board with electrically conductive plating formed on each side of, and spanning the length of, the elongated aperture. In a most preferred embodiment of the present invention, the elongated aperture of the measurement sensor is longer than the elongated aperture of the calibration sensor.

In another embodiment of the present invention, the control circuitry is in communication with the calibration sensor and measurement sensor through electrically conductive channels extending from the top of the PCB to each sensor. Further, the electrically conductive plating extends laterally into the body of the PCB between first and second faces of the PCB.

In a further embodiment of the present invention, the PCB further comprises control circuitry, which comprises a power source, a microcontroller, and communication means. Preferably, the communication means comprises a radio frequency communication means.

Through these embodiments of the present invention, the conductivity of the fluid is sensed with the calibration electrode and compared with the conductivity reading of the measurement electrode to determine fluid level.

In a second aspect of the present invention, a device for sensing fluid level is provided comprising a printed circuit board comprising a power source, microcontroller, a first elongated aperture and a second elongated aperture, said first and second elongated apertures aligned end to end, a length of electrically conductive plating formed along the inner sides of each elongated aperture, and electrically conductive channels formed on the PCB connecting each length of electrically conductive plating to the microcontroller and power source. In a preferred embodiment of the present invention, the electrically conductive plating is further formed on a front face and rear face of the PCB adjacent to each elongated aperture and the electrically conductive plating further extends from the surface of the PCB surrounding each elongated aperture into the interior of the PCB.

In a third aspect of the present invention, a method for determining a fluid level within a reservoir is provided comprising the steps of: providing a calibration sensor completely immersed in the fluid and having a known length, providing a measurement sensor at least partially immersed in the fluid, sensing an electrical property of the fluid through the calibration sensor, sensing the same electrical property of the fluid through the measurement sensor, and determining the fluid level as it relates to the length of the measurement electrode exposed to the fluid.

In one embodiment of the present invention, the fluid level is determined by comparing the degree of the sensed electrical property of the calibration electrode to the degree of the sensed electrical property of the measurement electrode. The sensed electrical property can be conductance and/or capacitance.

In a further embodiment of the present invention, the step of determining the fluid level comprises computing the ratio of the measurement reading to the calibration reading and multiplying the result by the ratio of the calibration length to the measurement length to yield the fraction of the measurement ratio which is immersed in the liquid. Then the determined fluid level is communicated to a remote location. In a preferred embodiment of the present invention, the determined fluid level is communicated using a radio frequency communication device.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### BRIEF DESCRIPTION OF THE DRAWINGS

FIG. 1 is a side view of a fluid level sensor in a preferred embodiment of the present invention.

FIG. 2 is a cross sectional view of the fluid level sensor of FIG. 1 taken along line I-I in an embodiment of the present invention.

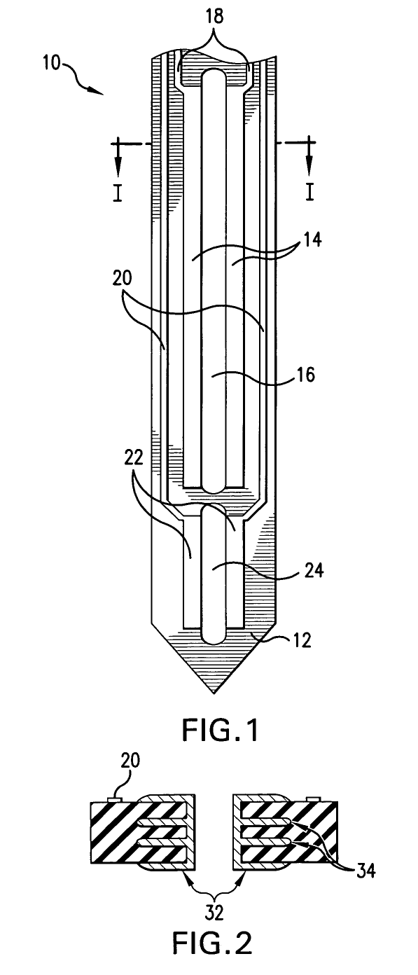

### DETAILED DESCRIPTION

A first aspect of the present invention provides an apparatus and method for electronically sensing fluid level. The apparatus comprises two sensors, a measurement sensor and a calibration sensor. The calibration sensor is completely immersed in the fluid and measures a property of the fluid. For example, the conductivity of the fluid can be sensed by the calibration sensor to establish a known conductivity for the fluid at a particular point in time. The measurement sensor, which is partially immersed in the fluid, measures the same property of the fluid and a comparison of the calibration sensor value and measurement sensor value provides the level of the fluid within the range of the measurement sensor.

The calibration sensor is immersed completely in the liquid. A property of the liquid is sensed through the calibration sensor thereby establishing a reference value for that property as it relates to the current state of the liquid. For example, if the conductivity of the liquid is the chosen property, the current passing through the liquid in the area of the calibration sensor provides a reference conductivity. Since the entire length of the calibration sensor is completely immersed in the liquid, the conductivity as a function of sensor length is determined. The same property is sensed by the measurement sensor thereby providing a measurement conductivity. The ratio of the measurement conductivity to the reference conductivity will yield the level within the measurement electrode.

Referring to the figures and a preferred embodiment of the present invention, the calibration sensor and the measurement sensor are incorporated into one device for sensing fluid level 10 fabricated on a printed circuit board (PCB) 12. The PCB 12 comprises two slots 16, 24 which are plated on each side by exposed conductive plating 14, 22 thereby forming electrodes on either side of the slots. A first slot 16 comprises the measurement sensor and a second slot 24, positioned below the first slot, comprises the calibration sensor. In this manner, the PCB comprising the measurement and calibration sensors may be disposed within the reservoir containing the liquid to be monitored. The calibration sensor is located below the measurement sensor to ensure that the calibration sensor remains completely immersed in the fluid at all times. Varying portions of the measurement sensor are immersed in the fluid depending on the fluid level within the reservoir.

The measurement sensor comprising the elongated slot 16 and electrodes 14 is preferably longer than the calibration sensor comprising elongated slot 24 and electrodes 22. A meaningful fluid level measurement occurs when the surface of the fluid is within the range of the measurement sensor, i.e. between the top and bottom of the measurement electrodes adjacent to the measurement slot. The calibration sensor is only required to sense a portion of the fluid within the reservoir. In one embodiment of the present invention, the measurement sensor electrodes 14 are substantially longer than the calibration sensor electrodes 22 to provide a large range of level sensing for the fluid.

Referring to FIG. 2, in a preferred embodiment of the present invention, the electrically conductive plating 32 extends across the entire cross section (depth) of the slot and at least partially along both faces of the PCB. Inner layers of electrically conductive plating 34 extend laterally into the body of the substrate PCB. The number of inner conductive layers 34 will vary depending on the thickness of the layers relative to the substrate PCB, however, their inclusion is desirable for added strength. The inner conductive layers 34 provide additional physical strength to the electrically conductive plating 32 surrounding the slots.

The electrically conductive plating on the calibration slot 22 and measurement slot 14 is connected to the electronics through electrically conductive channels 18, 20 on the PCB. These electrically conductive channels connect the sensors to the electronic circuitry of the device. The electronic circuitry (not shown) is positioned above the highest possible fluid level, and in a preferred embodiment of the present invention, outside the fluid reservoir.

In a preferred embodiment of the present invention, the several components are incorporated into a single unit comprising a PCB containing the sensors, control circuitry, and a power source, all in electrical communication with one another. The PCB contains, among other things, a processor, such as a microprocessor or microcontroller, for storing and processing lubricant condition data obtained by the electrodes, as well as conventional signal conditioning circuitry such as amplifiers and buffers, and signal generation and communication devices, such as, for example, a radio frequency (“RF”) communicator. In a most preferred embodiment of the present invention, the electronics and sensor assembly are secured to a mounting plug such as a SAE-J2244 M18×1.5 mounting plug for an engine block mount.

In operation, when the reservoir is full or the fluid level is otherwise above the top of the slot on the measurement sensor, the reading of the measurement sensor divided by the measurement sensor length will equal the reading from the calibration sensor divided by the calibration sensor length. The conductivity per unit length of electrode will be the same for the measurement sensor and the calibration sensor.

As the fluid level decreases such that a portion of the measurement sensor is above the surface of the liquid, the conductivity, as a function of unit length of the electrode, will be less than 1 indicating less conductivity between the measurement electrodes than the calibration electrodes indicating a less than full reservoir. When the level of the fluid drops below the bottom of the measurement sensor, the level ratio will be 0 indicating the sensor can no longer detect conductivity between the measurement electrodes.

To summarize, the fluid level expressed as a percentage of the maximum fluid level can be expressed by the following equation:

$$\frac{\frac{Cm}{Lm}}{\frac{Cc}{Lc}} * 100 = \% full$$

where
Cm=conductivity reading from the measurement sensor
Lm=total length of the measurement sensor
Cc=conductivity reading from the calibration sensor
Lc=total length of the calibration sensor.

The system is further configured to communicate a signal, such as a radio frequency signal, to an external data retrieval device, such as a hand-held computing device, to indicate the changes in the condition or level of fluid within the reservoir. In so doing, an observer such as a vehicle operator or inspector can easily determine the state of the fluid. The term communication, as used herein, generally relates to a transfer of data and may include transmission or reflection of a signal.

In an embodiment of the present invention, an RF communication system is employed such as the one described in U.S. patent application Ser. No. 10/697,743 (Pub. No. 2004/0083811), filed Oct. 30, 2003 entitled “Electronic Hubodometer” herein incorporated by reference in full. Generally, this system comprises an interrogator at a remote location that generates a modulated or unmodulated radio frequency interrogation signal, and an RF “tag” incorporated into the sensor to receive the signal from the sensor electronics and communicate data back to the interrogator.

The RF tag is activated when an RF signal is transmitted or broadcast from the interrogator and impinges the antenna on the tag. This signals the tag to activate. Electronic controls on the tag receive sensor information and communicate this information back to the interrogator by modulating the antenna on the tag according to a predetermined format. As additional RF energy from the interrogator impinges the antenna on the tag, a portion of that energy will be reflected back to the interrogator. The reflected energy will vary in form due to modulations in the antenna. The interrogator receives this reflected energy containing modulations from the tag's antenna and deciphers the modulations to extract sensor information.

In an embodiment of the present invention the signal communicated by the fluid level sensor may be broadcast to a remote location, such as a central monitoring station, by means of satellite transmission or the like. Alternatively, the signal may be communicated to the passenger compartment of the vehicle to provide the driver with information concerning the condition of the fluid within the reservoir. This information could be in the form of a visual or audible alarm signal which would warn the driver of a dangerous condition such as a dangerously low lubricant level, advising the driver to pull over to the side of the road so as not to risk an accident.

In a preferred embodiment of the present invention, the fluid level is continuously monitored by the calibration and measurement sensors. Monitoring is performed by way of an instruction set coded into the processor associated with the PCB, and the instructions set preferably includes a feedback loop or subroutine which evaluates signals observed by the electrodes. Changes in the conductivity of the lubricant can result from circumstances such as variations in the acidity, amount of metallic and non-metallic particles or contaminants in the lubricant, which could be present due to the degradation or wear of the component parts, water ingress, or from other debris. However, since the conductivity of the fluid can be continuously or periodically monitored by the calibration electrode, changes in conductivity will not affect the fluid level measurement by the device.

Those skilled in the art will readily appreciate that the design of the circuit board can vary depending upon the type of sensor employed in the system and the manner by which data is processed and communicated without departing from the spirit or scope of the subject disclosure.

The hardware implementations of the various embodiments of the present invention will vary, but all have the characteristic of enabling a ratiometric conductively derived oil level, independent of temperature and oil condition. For example, the sensor could be self-contained, with an internal power source (battery, solar cell, etc.) and all signal processing self-contained.

In a further embodiment of the present invention, the level sensor is employed to detect problems in the fluid not related to fluid level. For example, given a known property of a fluid, such as the conductivity of lubricating oil, which changes as the oil degrades, an alarm signal is generated when the property exceeds a certain threshold which has been predetermined to be a safe operating parameter of the fluid. In this manner, even when the fluid reservoir is full, fluid which has been contaminated to degraded past a certain predetermined point would register a “needs maintenance” signal.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A device for sensing fluid level comprising:
a calibration sensor completely immersed in a fluid; and,
a measurement sensor at least partially immersed in the same fluid;
wherein said calibration sensor is disposed in the fluid at a position lower than the lowest level of the measurement sensor.

2. The device of claims 1, wherein the calibration sensor and measurement sensor are disposed on a printed circuit board (PCB).

3. The device of claim 2, wherein the calibration sensor comprises an elongated aperture in the printed circuit board with electrically conductive plating formed on each side of, and spanning the length of, the elongated aperture.

4. The device of claim 2 wherein the measurement sensor comprises an elongated aperture in the printed circuit board with electrically conductive plating formed on each side of, and spanning the length of, the elongated aperture.

5. The device of claim 4, wherein the elongated aperture of the measurement sensor is longer than the elongated aperture of the calibration sensor.

6. The device of claim 5, wherein the control circuitry is in communication with the calibration sensor and measurement sensor through electrically conductive channels extending from the top of the PCB to each sensor.

7. The device of claim 4, wherein the electrically conductive plating extends laterally into the body of the PCB between the first and second faces of the PCB.

8. The device of claim 2, wherein the PCB further comprises control circuitry.

9. The device of claim 8, wherein the control circuitry comprises a power source, a microcontroller, and communication means.

10. The device of claim 9 wherein the communication means comprises a radio frequency communication means.

11. The device of claim 1, wherein the conductivity of the fluid is sensed with the calibration electrode and compared with the conductivity reading of the measurement electrode to determine fluid level.

12. A device for sensing fluid level comprising:
a printed circuit board comprising a power source, microcontroller, a first elongated aperture and a second elongated aperture, said first and second elongated apertures aligned end to end;
a length of electrically conductive plating formed along the inner sides of each elongated aperture; and
electrically conductive channels formed on the PCB connecting each length of electrically conductive plating to the microcontroller and power source.

13. The device of claim 10, wherein the electrically conductive plating is further formed on a front face and rear face of the PCB adjacent to each elongated aperture.

14. The device of claim 10, wherein the electrically conductive plating further extends from the surface of the PCB surrounding each elongated aperture into the interior of the PCB.

15. A method for determining a fluid level within a reservoir comprising:
providing a calibration sensor completely immersed in the fluid and having a known length;
providing a measurement sensor at least partially immersed in the fluid;
sensing an electrical property of the fluid through the calibration sensor;
sensing the same electrical property of the fluid through the measurement sensor; and
determining the fluid level as it relates to the length of the measurement electrode exposed to the fluid.

16. The method of claim 15, wherein the fluid level is determined by comparing the degree of the sensed electrical property of the calibration electrode to the degree of the sensed electrical property of the measurement electrode.

17. The method of claim 15, wherein the sensed electrical property is conductance.

18. The method of claim 15, wherein the sensed electrical property is capacitance.

19. The method of claim 15, wherein the step of determining the fluid level comprises computing the ratio of the measurement reading to the calibration reading and multiplying the result by the ratio of the calibration length to the measurement length to yield the fraction of the measurement ratio which is immersed in the liquid.

20. The method of claim 15, further comprising communicating the determined fluid level to a remote location.

21. The method of claim 20, wherein the determined fluid level is communicated using a radio frequency communication device.
